(19) United States
(12) Patent Application Publication
(10) Pub. No.: US 2003/0092786 A1
(43) Pub. Date: May 15, 2003

(54) Prepolymers useful for production of flame-retardant polyurethanes

(76) Inventors: Ingo Brassat, Leverkusen (DE); Wolfgang Friederichs, Koln (DE); Christoph Hollmann, Korschenbroich (DE); Robert Vieler, Dormagen (DE); Uwe Kunzel, Leverkusen (DE)

Correspondence Address: BAYER POLYMERS LLC, 100 BAYER ROAD, PITTSBURGH, PA, 15205, US

(21) Appl. No.: 10/292,705

(22) Filed: Nov. 12, 2002

(30) Foreign Application Priority Data
Nov. 15, 2001 (DE) 10156247.0

(51) Int. Cl. C08J 9/00; C08G 18/00

(52) U.S. Cl. 521/82; 528/44

(57) ABSTRACT

An NCO-terminated prepolymer is produced by reacting a solid halogenated diol and a polyisocyanate. This prepolymer is useful in the production of flame-retardant polyurethanes.

### BACKGROUND OF THE INVENTION

The present invention relates to NCO-terminated prepolymers produced from a solid halogenated diol and a polyisocyanate, to a process for the production of such prepolymers and to the use of such prepolymers for the production of flame-retardant polyurethanes.

Flammable blowing agents are commonly used in the preparation of rigid polyurethane and polyurethane/urea (“PU”) foams. Examples of such blowing agents are hydrocarbons such as pentane, but also a number of HCFCs and HFCs known from the literature. This leads to problems when making the foams flame retardant, which is why high-performance flame retardants are generally added to the polyurethane formulation.

Some of the best known flame retardants are tris(2-chloroisopropyl) phosphate, triphenyl phosphate, diphenyl cresyl phosphate and triethyl phosphate. The disadvantage of including such flame retardants in the foam-forming mixture is, however, that these expensive flame retardants frequently need to be used in a relatively large quantity. Furthermore, phosphorus-containing flame retardants can display a plasticizing effect, which leads to a reduction in the compressive strength and dimensional stability of the rigid foams. Moreover, such flame retardants are volatile to a certain extent and can be released from the rigid PU foam over time, whereby some of the flame retardant action is lost.

Halogen-containing chemical compounds having isocyanate-reactive hydrogen atoms are frequently used to increase the flame resistance of rigid foams.

DE-OS 195 28 537, for example, proposes the use of tribromoneopentyl alcohol as a flame retardant for rigid PU foams. The disadvantage of this flame retardant is that the degree of crosslinking of the resulting polyurethanes is reduced by the monofunctional alcohol and highly functional and generally highly viscous polyols have to be used to compensate for the monofunctional alcohol's effect.

Other halogen-containing flame retardants known to the person skilled in the art are derivatives of tetrabromophthalic acid and modified 2,3-dibromo-2-butene-1,4-diols. For economic reasons, however, the application possibilities for these flame retardants are limited.

The use of solid flame retardants in rigid PU foams is also known. U.S. Pat. No. 4,221,875, for example, discloses flame-retardant PU foams produced by reacting a raw material formulation containing a melamine powder. GB-A 2 177 405 also describes flame-retardant PU foams made with melamine as the sole flame retardant.

Tetrabromobisphenol-A (2,2-bis(3,5-dibromo-4-hydroxyphenyl) propane, TBBPA), a flame retardant that is commonly used in thermoplastics, is taught in EP-A 108 713 to be useful as a flame retardant in the production of rigid PU foams in combination with dimethyl methane phosphonate (DMMP) and/or diethyl ethane phosphonate (DEEP) and a triaryl phosphate, dialkyl phosphate or alkyl/aryl phosphate.

The disadvantage of all solid flame retardants is that they are difficult to process, since rigid PU foams are conventionally prepared by the so-called high pressure process. A further disadvantage of solid flame retardants is their non-homogeneous distribution in the polyurethane matrix. Undesirable interactions between the solid particles and the polyurethane matrix can lead to defects in the cell structure (elevated proportion of open cells) and hence to a deterioration in the thermal insulation. Moreover, undesirable decomposition reactions can arise due to catalytic surface effects, which may lead to discoloration in the vicinity of the solid particles.

Given the high efficacy of TBBPA, attempts have been made to use liquid derivatives of this flame retardant in rigid PU foams. Thus the use of liquid reaction products of TBBPA with alkylene oxides is described in DE-OS 24 50 540 and EP-A 270 033, for example. The disadvantage is that the production of these derivatives is technically complex and because of their low halogen content they have to be used in markedly larger quantities than pure TBBPA and can therefore noticeably impair the mechanical/physical properties of the rigid PU foams made with these derivatives.

GB-A 2 061 289 discloses liquid low-molecular weight reaction products of a) at least one polyisocyanate (or NCO quasi-prepolymer) and at least one monoalcohol and b) at least one monoisocyanate and at least one mono- or polyol (including halogenated diols such as TBBPA, for example). A monofunctional alcohol is therefore reacted with half the molar quantity of diisocyanate or difunctional alcohol with twice the molar quantity of monoisocyanate to form a diurethane. These low-molecular-weight compounds are added to PU formulations for foams as additives. They are non-reactive, liquid additives which are not incorporated into the polyurethane matrix and which due to their plasticizing effect can lead to a deterioration in the mechanical/physical properties of the rigid PU foams.

### SUMMARY OF THE INVENTION

It has now been found that the above disadvantages can be avoided by using an NCO-terminated prepolymer which is the reaction product of a solid, halogenated diol and a polyisocyanate to produce a PU foam.

### DETAILED DESCRIPTION OF THE INVENTION

The present invention provides an NCO-terminated prepolymer which is a reaction product of i) at least one halogenated diol that is solid at room temperature and ii) at least one polyisocyanate, and optionally iii) additives such as solvents, catalysts or stabilizers. The invention also provides a process for the production of such prepolymers and of flame-retardant rigid PU foams made with the prepolymers of the present invention.

Halogenated diols that are in solid form at room temperature (25° C.) are suitable for use as reaction component (i) in the practice of the present invention. Brominated diols, preferably dibromoneopentyl glycol, dibromobisphenol A, tetrabromobisphenol A and/or derivatives of these compounds, such as e.g. tetrabromobisphenol-A-oligocarbonate, are preferably used. Tetrabromobisphenol A is most preferably used.

Any of the known aliphatic, cycloaliphatic, araliphatic and preferably the aromatic polyvalent isocyanates are useful as reaction component (ii) in the practice of the present invention.

Specific examples of suitable isocyanates include: alkylene diisocyanates with from 4 to 12 carbon atoms in the alkylene radical, such as 1,12-dodecane diisocyanate, 2-ethyl tetramethylene-1,4-diisocyanate, 2-methyl pentamethylene-1,5-diisocyanate, tetramethylene-1,4-diisocyanate, and preferably hexamethylene-1,6-diisocyanate; cycloaliphatic diisocyanates, such as cyclohexane-1,3-diisocyanate and cyclohexane-1,4-diisocyanate and any mixtures of these isomers, 1-isocyanato-3,3,5-trimethyl-5-isocyanatomethyl cyclohexane (isophorone diisocyanate), 2,4- and 2,6-hexahydrotolulene diisocyanate and any mixtures of these isomers, 4,4′-, 2,4′- and 2,2′-dicyclohexyl methane diisocyanate and any mixtures of these isomers; and preferably, aromatic diisocyanates and polyisocyanates, such as e.g. 2,4- and 2,6-toluene diisocyanate and the corresponding blends of isomers, 4,4′-, 2,4′- and 2,2′-diphenyl methane diisocyanate and the corresponding blends of isomers, mixtures of 4,4′- and 2,4′-diphenyl methane diisocyanates, polyphenyl polymethylene polyisocyanates, mixtures of 4,4′-, 2,4′- and 2,2′-diphenyl methane diisocyanates and polyphenyl polymethylene polyisocyanates (crude MDI) and mixtures of crude MDI and toluene diisocyanates. The organic diisocyanates and polyisocyanates can be used individually or in the form of blends or mixtures thereof.

So-called modified polyvalent isocyanates, i.e. products that are obtained by chemical reaction of an organic diisocyanate and/or polyisocyanate, are frequently also used. Examples of such modified isocyanates include: diisocyanates and/or polyisocyanates containing ester, urea, biuret, allophanate, carbodiimide, isocyanurate, uret dione and/or urethane groups. Specific examples include: organic, preferably aromatic polyisocyanates containing urethane groups, with an NCO content of from about 33.6 to about 15 wt. %, preferably from about 31 to about 21 wt. %, relative to the overall weight. Examples are crude MDI or 2,4- or 2,6-toluene diisocyanate modified with a low-molecular diol, triol, dialkylene glycol, trialkylene glycol or polyoxyalkylene glycol with a number-average molecular weight of up to 6000 g/mol, particularly up to 1500 g/mol. Examples of suitable di- or polyoxyalkylene glycols are diethylene, dipropylene, polyoxyethylene, polyoxypropylene and polyoxypropylene polyoxyethylene glycols, triols and/or tetrols. Also suitable are prepolymers containing NCO groups, with NCO contents of from 3.5 to 25 wt. %, preferably 14 to 21 wt. %, relative to the overall weight, produced from polyester and/or preferably polyether polyols and 4,4′-diphenyl methane diisocyanate, blends of 2,4′- and 4,4′-diphenyl methane diisocyanate, 2,4- and/or 2,6-toluene diisocyanate or crude MDI. Liquid polyisocyanates containing carbodiimide groups and/or isocyanurate rings, with NCO contents of from 15 to 33.6 wt. %, preferably from 21 to 31 wt. %, relative to the overall weight, are also particularly useful when based, for example, on 4,4′-, 2,4′- and/or 2,2′-diphenyl methane diisocyanate and/or 2,4- and/or 2,6-toluene diisocyanate.

The modified polyisocyanates can be mixed with one another or with unmodified organic polyisocyanates such as 2,4′-, 4,4′-diphenyl methane diisocyanate, crude MDI, 2,4- and/or 2,6-toluene diisocyanate.

Diphenyl methane diisocyanate isomer blends or crude MDI and in particular crude MDI with a diphenyl methane diisocyanate isomer content of from 30 to 55 wt. %, as well as urethane group-containing polyisocyanate mixtures based on diphenyl methane diisocyanate with an NCO content of from 15 to 33 wt. % are especially preferred isocyanates.

In order to prepare the NCO-terminated prepolymers of the present invention, the reaction components (i) and (ii) are used in a molar ratio to each other such that there is a molar excess of component (ii). The content of NCO groups in the prepolymers of the present invention is generally from about 5 to about 45 wt. %, preferably from about 10 to about 40 wt. %, and most preferably from about 20 to about 30 wt. %, and can be determined by suitable means, for example by titration.

The prepolymerization can be performed in a batch process or continuously at a temperature in the range of from 20° C. to 160° C., preferably from 40° C. to 140° C., most preferably from 60° C. to 120° C. The reaction is preferably continued until the polyol component is completely converted. The conversion can be tracked via the rise in viscosity of the prepolymer and the reaction is continued until constant viscosity is reached.

The NCO-terminated prepolymers of the present invention may be produced directly before production of the rigid PU foams, for example by blending together reaction components (i), (ii) and optionally (iii) in a batch process or continuously and feeding the NCO-terminated prepolymer that is formed directly to the mixing head used for production of the rigid PU foam.

Examples of the additives (iii) that can optionally be used in the prepolymerization include catalysts which accelerate the reaction of reaction component (i) containing isocyanate-reactive hydrogen atoms, in particular hydroxyl groups, with the organic, optionally modified polyisocyanates (ii). Examples of suitable catalysts are organic metal compounds, preferably organic tin compounds, such as tin(II) salts of organic carboxylic acids, for example tin(II) acetate, tin(II) octoate, tin(II) ethyl hexanoate, tin(II) laurate and the dialkyl tin(IV) salts of organic carboxylic acids such as dibutyl tin diacetate, dibutyl tin dilaurate, dibutyl tin maleate, dioctyl tin diacetate and tertiary amines such as triethylamine, tributylamine, dimethyl cyclohexylamine, dimethyl benzylamine, N-methyl imidazole, N-methyl, N-ethyl, N-cyclohexyl morpholine, N,N,N′,N′-tetramethyl ethylene diamine, N,N,N′,N′-tetramethyl butylene diamine, N,N,N′,N′-tetramethyl hexylene-1,6-diamine, pentamethyl diethylene triamine, tetramethyl diaminoethyl ether, bis(dimethyl aminopropyl) urea, dimethyl piperazine, 1,2-dimethyl imidazole, 1-azabicyclo-[3,3,0]-octane, 1,4-diazabicyclo-[2,2,2]-octane, as well as alkanolamine compounds such as triethanolamine, tris-isopropanolamine, N-methyl and N-ethyl diethanolamine and dimethyl ethanolamine. Other examples of catalysts are: tris(dialkylamino)-s-hexahydrotriazines, in particular tris(N,N-dimethylamino)-s-hexahydrotriazine; tetraalkyl ammonium salts such as N,N,N-trimethyl-N-(2-hydroxypropyl) formate, N,N,N-trimethyl-N-(2-hydroxypropyl)-2-ethyl hexanoate; tetraalkyl ammonium hydroxides such as tetramethyl ammonium hydroxide; alkali hydroxides such as sodium hydroxide; alkali alcoholates such as sodium methylate and potassium isopropylate; and alkali or alkaline-earth salts of fatty acids with 1 to 20 carbon atoms and optionally lateral OH groups.

Tertiary amines, tin and bismuth compounds, alkali and alkaline-earth carboxylates, quaternary ammonium salts, s-hexahydrotriazines and tris(dialkyl aminomethyl) phenols are preferably used.

The amount of catalyst or catalyst combination used, relative to the overall weight of the prepolymer batch, is preferably from about 0.001 to about 5 wt. %, preferably from about 0.002 to about 2 wt. %.

The prepolymerization can moreover be performed in the presence of further additives (iii) such as stabilizers or light stabilizers.

Solvents can optionally also be added as further additives (iii) for the prepolymerization. If used, the amount of solvent can be up to 50 wt. %, relative to the total amount of the finished prepolymer. Suitable solvents are low-boiling hydrocarbons with boiling points below 100° C., preferably below 50° C. as they are conventionally used for the production of polyurethane materials. Other suitable solvents are paraffins, halogenated hydrocarbons, halogenated paraffins, ethers, ketones, alkyl carboxylates, alkyl carbonates or liquid flame retardants such as alkyl phosphates, such as e.g. triethyl phosphate or tributyl phosphate, halogenated alkyl phosphates such as e.g. tris(2-chloropropyl) phosphate or tris(1,3-dichloropropyl) phosphate, aryl phosphates such as diphenyl cresyl phosphate, and phosphonates such as diethyl ethane phosphonate. Mixtures of the cited solvents and/or flame retardants can likewise be used.

Furthermore, on completion of the reaction, an NCO-terminated prepolymer prepared in accordance with the present invention may be separated from any auxiliary substances or solvents that may have been added by conventional work-up methods such as distillation, for example.

The properties, e.g. viscosity of the NCO-terminated prepolymers of the present invention may also be adjusted by the subsequent addition of additives (iii) described above or by mixing them with polyisocyanates. Suitable isocyanates for this purpose are the compounds described for use as reaction component (ii).

The NCO-terminated prepolymers of the present invention can be used for the production of flame-retardant polyurethanes, for example PU foams, in particular rigid PU foams.

Flame-retardant rigid PU foams may be produced in accordance with the present invention by reacting

a) an NCO-terminated prepolymer of the present invention, optionally in combination with

b) one or more other organic polyisocyanates,

c) one or more compounds having at least two isocyanate-active hydrogen atoms and a number-average molecular weight of from −400 to about 20,000 g/mol,

d) optionally, one or more chain extenders and crosslinking agents having at least two isocyanate-active hydrogen atoms and a molecular weight of from about 32 to 399 g/mol, in the presence of

e) a partially halogenated chlorofluorocarbon, fluorocarbon, hydrocarbon and/or mixture thereof as a physical blowing agent, and optionally,

f) a phosphorus-containing and/or halogen-containing flame retardant or mixture thereof and

g) optionally, a chemical blowing agent different from e) and any of the auxiliaries and/or additives known to be useful for the production of polyurethanes

at an NCO Index of from 80 to 500, preferably from 100 to 300, most preferably from 100 to 230.

The isocyanates described above as being suitable for use as reaction component (ii) for the production of the prepolymers of the present invention are also suitable for use as component b) in the above-described reaction mixture.

Formulation component (c) includes compounds having at least two isocyanate-reactive hydrogen atoms with a number-average molecular weight of from 400 to about 20,000 g/mol, especially those with a number-average molecular weight of from 400 to about 10,000 g/mol, most preferably from 400 to 6000 g/mol. In addition to compounds having amino groups, thiol groups or carboxyl groups, these preferably include compounds having hydroxyl groups, in particular compounds having two to eight hydroxyl groups such as polyethers, polyesters, polycarbonates and/or polyester amides having at least two to six hydroxyl groups. Such compounds are known to be useful for the production of homogeneous and of cellular polyurethanes by those skilled in the art. Examples of such compounds are given in DE-OS 28 32 253, p. 11-18.

Chain extenders and crosslinking agents (d) are optionally included in the foam-forming mixture. These are compounds having at least two isocyanate-reactive hydrogen atoms and a molecular weight of 32 to 399 g/mol. Examples of such chain extenders and crosslinking agents include compounds having hydroxyl groups and/or amino groups and/or thiol groups and/or carboxyl groups, preferably compounds having hydroxyl groups and/or amino groups. These compounds generally have from two to eight, preferably two to four isocyanate-reactive hydrogen atoms. Examples of these compounds are given in DE-OS 28 32 253, p. 19 ff.

Partially halogenated chlorofluorocarbons (HCFCs), for example 1,1-dichloro-1-fluoroethane (R141b); fluorocarbons (HFCs), for example 1,1,1,3,3-pentafluoropropane (R245fa), 1,1,1,3,3-pentafluorobutane (R365mfc) and/or 1,1,1,2-tetrafluoroethane (R134a); and/or hydrocarbons, preferably C₃-C₇ alkanes, particularly preferably pentane, isopentane and cyclopentane and/or mixtures thereof, may be used as blowing agent (e).

Phosphorus-containing and/or halogen-containing flame retardants (f) are optionally added to the formulation. Examples of such flame retardants include: triphenyl phosphate, triethyl phosphate, diphenyl cresyl phosphate, tris(2-chloroisopropyl) phosphate, derivatives of tetrabromophthalic acid, modified 2,3-dibromo-2-butene-1,4-diols and/or mixtures thereof.

Further chemical blowing agents, auxiliary substances and additives may optionally be incorporated as reaction component (g). Examples of such materials include: water as chemical blowing agent; additional catalysts of known type, in quantities of up to 10 wt. %, relative to the total amounts of formulation components (c) to (g); surface-active additives such as emulsifiers and foam stabilizers; reaction retarders, e.g., acid-reacting substances such as hydrochloric acid or organic acid halides; cell regulators of known type such as paraffins or fatty alcohols or dimethyl polysiloxanes; pigments or dyes; stabilizers against the effects of ageing and weathering; plasticizers; substances having a fungistatic and/or bacteriostatic effect; and/or fillers such as barium sulfate, kieselguhr, silica sand, expandable graphite, carbon black and/or prepared calcium carbonate.

Such auxiliary substances and additives are described in DE-OS 27 32 292, p. 21-24 and in G. Oertel (Ed.): “Kunststoff-Handbuch”, volume VII, Carl Hanser Verlag, Munich, 1993, p. 104-127.

The rigid PU foams of the present invention are advantageously produced by the so-called one-shot method, for example with the aid of high-pressure or low-pressure technology, in open or closed molds (for example, metal molds). It has proven particularly advantageous to use the two-component method and to combine the components (c), (d), (f) and (g) in the processing component (A) and to use the NCO-terminated prepolymers (a) and optionally polyisocyanates (b) as processing component (B). The blowing agent (e) can be added either to processing component (A) or (B) or alternatively partly to (A) and partly to (B).

The processing components are mixed at a temperature of from 15° C. to 90° C., preferably 20° C. to 60° C. and most preferably 20° C. to 40° C. and introduced into the mold, optionally under elevated pressure. In closed molds, more foam-forming reaction mixture than is required to completely fill the mold can also be used. Compressed foams are then obtained. A preferred variant of foam production is the so-called twin conveyor belt technology.

The rigid PU foams or rigid molded foams of the present invention have a density of from about 15 to 500 kg/m³, preferably from 25 to 240 kg/m³ and most preferably from 30 to 100 kg/m³.

The foams of the present invention are particularly suitable as an insulating material in the building sector, e.g. as an interlayer for sandwich elements or as insulating sheets for the thermal insulation of floors, walls, ceilings, roofs and pipes. These foams can also be used for insulation purposes in vehicle construction, particularly in rail vehicle, road vehicle and ship construction.

The rigid PU foams produced using the NCO-terminated prepolymers of the invention are characterized by good mechanical/physical properties, in particular dimensional stability and compressive strength, and by advantageous burning behaviour. Surprisingly, the use of the prepolymers according to the invention significantly improves thermal conductivity as compared with comparable foams produced using non-prepolymerized standard isocyanates. The use of the prepolymers of the invention can also achieve an improvement in comparison to foams produced with solid TBBPA.

Having thus described the invention, the following Examples are given as being illustrative thereof. All parts and percentages given in these Examples are parts by weight or percentages by weight, unless otherwise indicated.

### EXAMPLES

The materials used in the Examples which follow were:

Polyol 1: Polyester ether alcohol based on phthalic anhydride, diethylene glycol and propylene oxide having a functionality of 2 and a hydroxyl value of 300 mg KOH/g.

Polyol 2: Polyester alcohol based on phthalic anhydride, adipic acid, oleic acid, trimethylol propane and diethylene glycol having a functionality of 2.9 and a hydroxyl value of 370 mg KOH/g.

Polyol 3: Mixture of polyether polyols and polyester polyols along with dibromobutene diol ether and tris(2-chloroisopropyl) phosphate having a functionality of approximately 3 and a hydroxyl value of 385 mg KOH/g (commercially available under the name Baymer® VP.PU 22HB16 from Bayer AG).

Isocyanate 1: Mixture of MDI isomers, NCO content 32.6 wt. % which is commercially available under the name Desmodur® VL 2854 from Bayer AG.

Isocyanate 2: Crude MDI, NCO content 31.5 wt. % which is commercially available under the name Desmodur® 44V10L from Bayer AG.

Isocyanate 3: Crude MDI, NCO content 31 wt. % which is commercially available under the name Desmodure® 44V40L from Bayer AG.

Isocyanate 4: Mixture of 2,4- and 2,6-bis(isocyanato)toluene, NCO content 48 wt. % which is commercially available under the name Desmodur® T80 from Bayer AG.

Isocyanate 5: Dicyclohexyl methane-4,4′-diisocyanate isomer blend, NCO content 32 wt. % which is commercially available under the name Desmodur® W from Bayer AG.

TCPP: Tris(2-chloroisopropyl) phosphate.

DBDE: Ixole® B251 dibromobutene diol ether which is commercially available from Solvay.

TBBPA: Tetrabromobisphenol A.

Stabilizer: Tegostab® B 8466 silicone stabilizer which is commercially available from Goldschmidt AG.

DMCHA: Dimethyl cyclohexylamine.

Production of the Prepolymers

The quantities of the polyol component (i) and the polyisocyanate component (ii) as shown in Table 1 were reacted under an inert gas atmosphere at the specified temperature with stirring until no further rise in viscosity was observed. The specified quantity of benzoyl chloride was added to the prepolymer during cooling to room temperature.

TABLE 1

| | Amount [parts by weight] | | | | | | | | |
|---|---|---|---|---|---|---|---|---|---|
| Example | 1 | 2 | 3 | 4 | 5 | 6 | 7 | 8 | 9 |
| TBBPA | 117 | 117 | 117 | 100 | 117 | 117 | 117 | 117 | |
| Dibromo- | | | | | | | | | 100 |
| neopentyl glycol | | | | | | | | | |
| Isocyanate 1 | 883 | | | | 177 | 265 | | | |
| Isocyanate 2 | | 883 | 883 | 900 | 704 | | | | 900 |
| Isocyanate 3 | | | | | | 618 | | | |
| Isocyanate 4 | | | | | | | 883 | | |
| Isocyanate 5 | | | | | | | | 883 | |
| Benzoyl | 100 | 100 | 100 | 100 | 100 | 100 | — | — | — |
| chloride [ppm] | | | | | | | | | |
| Reaction time | 5 | 5 | 3 | 5 | 5 | 5 | 5 | 5 | 3.5 |
| [h] | | | | | | | | | |
| Temperature | 100 | 100 | 105 | 100 | 100 | 100 | 100 | 100 | 80 |
| [° C.] | | | | | | | | | |
| NCO content* | 26.9 | 25.2 | 25.7 | 26.9 | 26.1 | 25.9 | 40.4 | 26.5 | 25.0 |
| [%] | | | | | | | | | |
| Viscosity | 240 | 4700 | 4800 | 2500 | 2200 | 5500 | 20 | 245 | 7700 |
| [mPas], 25° C. | | | | | | | | | |

*) Tritrimetric determination of the NCO content:

The NCO value of the prepolymer was determined by reacting it with dibutylamine and then titrating it with hydrochloric acid. As a general rule, not only the NCO content of the free NCO groups in the prepolymer is found by this method but also a higher NCO content, which at best corresponds to that of the mixture of isocyanate and polyol component (See point 2 below.). This is due to the fact that dibutylamine can displace and release the phenolic polyol component from the prepolymer. In order to determine the proportion of isocyanate groups chemically bonded with tetrabromobisphenol A (See point 1 below.) and the NCO content of the prepolymer (See point 3 below.), the following procedure can be used, for example:

1. The prepolymer (10.00 g, Example 2, Table 1) was dissolved under an inert gas atmosphere in anhydrous chlorobenzene (40.00 g) and heated to 50° C. A molar excess (relative to the NCO groups) of anhydrous ethanol (4.29 g) was added to the solution and it was stirred for 5 h at 50° C. 25 ml of a 1 N dibutylamine solution in chlorobenzene were added to part of the solution (5.43 g), stirred for 5 min, 150 ml anhydrous acetone and a few drops of bromophenol blue added and titration performed with 1 N hydrochloric acid. An NCO content of 2.1 wt. % was found.

2.25 ml of a 1 N dibutylamine solution in chlorobenzene were added to 1 g of the prepolymer, stirred for 5 min, 150 ml anhydrous acetone and a few drops of bromophenol blue were added and titration performed with 1 N hydrochloric acid. An NCO content of 27.3 wt. % was found.

3. This resulted in a corrected NCO content of the prepolymer of 25.2 wt. %.

Production of Rigid PU Foams:

A polyol component was prepared from the components c) to g) specified in Table 2. This polyol component was mixed with the isocyanate component (40° C.) at a temperature of 25° C., poured into a wooden mold (8 l) and allowed to expand. The resulting foams had a density of 35 kg/m³. The foam properties set out in Table 2 were determined using foam samples that had been stored for 24 h.

TABLE 2

| Example | 10* | 11* | 12* | 13 | 14 | 15* | 16 |
|---|---|---|---|---|---|---|---|
| Polyol 1 [parts by wt.] | 50 | 50 | 50 | 50 | 50 | | |
| Polyol 2 [parts by wt.] | 50 | 50 | 50 | 50 | 50 | | |
| Polyol 3 [parts by wt.] | | | | | | 98.2 | 98.2 |
| Glycerol [parts by wt.] | 8 | 8 | 8 | 8 | 8 | | |
| TCPP [parts by wt.] | 50 | 20 | 20 | 20 | 20 | | |
| DBDE [parts by wt.] | | 24.6 | | | | | |
| TBBPA (solid) [parts | | | 24.6 | | | | |
| by wt.] | | | | | | | |
| Stabilizer [parts | 2 | 2 | 2 | 2 | 2 | 2 | 2 |
| by wt.] | | | | | | | |
| DMCHA [parts | 1.2 | 1.2 | 1.2 | 1.2 | 1.2 | 1.3 | 1.3 |
| by wt.] | | | | | | | |
| Water [parts | 2.3 | 2.3 | 2.3 | 2.3 | 2.3 | 1.7 | 1.7 |
| by wt.] | | | | | | | |
| n-Pentane [parts | 12.5 | 13 | 12.5 | 12.5 | 12.5 | | |
| by wt.] | | | | | | | |
| Isocyanate 2 [parts | 175 | 185 | 175 | | | 140 | |
| by wt.] | | | | | | | |
| Prepolymer (Ex. 2) | | | | 210 | | | 140 |
| [parts by wt.] | | | | | | | |
| Prepolymer (Ex. 9) | | | | | 220 | | |
| [parts by wt.] | | | | | | | |
| Dimensional stability | −9.0 | 1.7 | −0.3 | 0.7 | 0.8 | −0.6 | −0.3 |
| [%], 24 h at 100° C. | | | | | | | |
| Dimensional stability | −0.5 | −0.3 | −0.3 | −0.7 | −0.5 | 0.3 | 0.2 |
| [%], 24 h at −22° C. | | | | | | | |
| Open cells [%] | 8 | 5 | 9 | 7 | 5 | 6 | 6 |
| Max. flame height¹ | 170 | 160 | 150 | 140 | 140 | 140 | 130 |
| [mm] | | | | | | | |
| Thermal conductivity | | | | | | 22.2 | 20.8 |
| [mW/mK], 23° C. | | | | | | | |
| Thermal conductivity² | | | | | | 27.7 | 25.8 |
| [mW/mK], 23° C. | | | | | | | |

*comparative example not according to the invention
¹according to DIN 4102 (pilot light test)
²after storage for 6 months at 70° C.

The foam obtained in comparative Example 12 displayed brown spots.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An NCO-terminated prepolymer comprising a reaction product of
i) at least one halogenated diol that is solid at room temperature and
ii) at least one polyisocyanate.

2. The prepolymer of claim 1 in which dibromoneopentyl glycol, dibromobisphenol A, tetrabromobisphenol A or a derivative thereof is used as the halogenated diol.

3. The prepolymer of claim 1 in which tetrabromobisphenol A is used as the halogenated diol.

4. A process for the production of the prepolymer of claim 1 in which the halogenated diol that is solid at room temperature and the polyisocyanate are reacted at 60 to 120° C.

5. A polyurethane comprising a reaction product of the prepolymer of claim 1 and an isocyanate-reactive compound.

6. A flame-retardant rigid PU foam comprising the reaction product of
a) the NCO-terminated prepolymer of claim 1,
b) optionally, an organic polyisocyanate which is different from a),
c) a compound having at least two isocyanate-active hydrogen atoms and a number-average molecular weight of 400 to 20,000 g/mol,
d) optionally, a chain extender and/or crosslinking agent having at least two isocyanate-active hydrogen atoms and a molecular weight of 32 to 399 g/mol,
e) a partially halogenated chlorofluorocarbon, a fluorocarbon, a hydrocarbon or a mixture thereof as a physical blowing agent,
f) optionally, a phosphorus-containing and/or halogen-containing flame retardant or mixture thereof and
g) optionally, a chemical blowing agent
produced at an NCO Index of from 80 to 500.
